(19) United States
(12) Patent Application Publication
(10) Pub. No.: US 2013/0208639 A1
(43) Pub. Date: Aug. 15, 2013

(54) APPARATUS AND METHOD FOR REDUCING POWER CONSUMPTION BY EARLY TERMINATION OF CELL BROADCAST DATA DECODING

(71) Applicant: QUALCOMM INCORPORATED, (US)

(72) Inventors: BHANU KIRAN JANGA, HYDERABAD (IN); AJIT GUPTA, HYDERABAD (IN); ASIMAVA BERA, HYDERABAD (IN); LIANGCHI HSU, SAN DIEGO, CA (US)

(73) Assignee: QUALCOMM INCORPORATED, SAN DIEGO, CA (US)

(21) Appl. No.: 13/764,576

(22) Filed: Feb. 11, 2013

(30) Foreign Application Priority Data
Feb. 13, 2012 (IN) 393/DEL/2012

(51) Int. Cl. H04W 52/02

(52) U.S. Cl. CPC H04W 52/0212
USPC 370/311

(57) ABSTRACT

The present disclosure presents example methods and apparatuses for conserving battery power in a mobile station. Some example methods may include receiving scheduling information from a network entity at the mobile station. In such examples, the scheduling information may include a scheduled final data frame. Furthermore, example methods may include receiving a final protocol data unit (PDU) of a service data unit (SDU) in an actual final data frame and comparing the scheduled final data frame to the actual final data frame. Moreover, in some examples, such methods may include initiating a sleep mode from the actual final data frame to the scheduled final data frame where the comparing indicates that the actual final data frame is earlier than the scheduled final data frame. As such, battery power at the mobile station may be conserved.

### CLAIM OF PRIORITY UNDER 35 U.S.C. §119

The present application for patent claims priority to Indian Ordinary Patent Application No. 393/DEL/2012 filed Feb. 13, 2012, entitled “Apparatus and Method for Reducing Power Consumption by Early Termination of Cell Broadcast Data Decoding,” which is assigned to the assignee hereof, and hereby expressly incorporated by reference herein.

### BACKGROUND

1. Field

Aspects of the present disclosure relate generally to wireless communication systems, and more particularly, to power management in wireless devices.

2. Background

Wireless communication networks are widely deployed to provide various communication services Communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems (e.g., cdma2000 1x (IS-2000)), time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple mobile stations (MSs), which may be also referred to as user equipment (UE). Each MS communicates with one or more base stations (BS), such as a Node B or other access point, via transmissions on the forward and reverse links. The forward link (or downlink) refers to the communication link from the BSs to the MSs, and the reverse link (or uplink) refers to the communication link from the MSs to the BSs.

In some aspects, a MS may receive scheduling information from a network entity, such as a BS, which indicates to the MS when certain data packets are likely to arrive. In some wireless systems a discontinuous reception is implemented, wherein service data units (SDUs) are broken down into smaller protocol data units (PDUs) at a network entity, the PDUs sent to one or more MSs, and the PDUs decoded and reassembled in the correct order at the MS(s) to complete transmission of the SDU. The scheduling information received before transmission of one or more PDUs may aid the MS in, for example, receiving the correct PDUs at the correct time, reassembling the PDUs in the correct order, and performing other vital functions.

In some cases, however, a MS may receive and decode a PDU before the full scheduled time set aside to receive and decode the PDU. Because the scheduling information overestimated the amount of time needed to receive and decode the PDU, there may be one or more blank frames between the end of the PDU and the end of the scheduled PDU receiving period. Though no data is actually received during these blank frames, the MS receiver nonetheless remains awake, ready to receiving and decoding the empty frames before the end of the scheduled PDU receiving period. Receiving and decoding these blank frames may be an unnecessary use of power and a drain on battery life. Thus, improvements in MS receiver power management are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects of the present disclosure include a method of conserving battery power in a mobile station, including receiving scheduling information from a network entity at the mobile station, wherein the scheduling information includes a scheduled final data frame, receiving a final protocol data unit (PDU) of a service data unit (SDU) in an actual final data frame, comparing the scheduled final data frame to the actual final data frame, and initiating a sleep mode from the actual final data frame to the scheduled final data frame where the comparing indicates that the actual final data frame is earlier than the scheduled final data frame.

Further contemplated herein is a computer program product, including a computer-readable medium comprising code for receiving scheduling information from a network entity at the mobile station, wherein the scheduling information includes a scheduled final data frame, receiving a final protocol data unit of a service data unit in an actual final data frame, comparing the scheduled final data frame to the actual final data frame, and initiating a sleep mode from the actual final data frame to the scheduled final data frame where the comparing indicates that the actual final data frame is earlier than the scheduled final data frame.

Additional aspects of the disclosure introduce an apparatus for wireless communication, which includes at least one processor and a memory coupled to the at least one processor, wherein the at least one processor is configured to receive scheduling information from a network entity at the mobile station, wherein the scheduling information includes a scheduled final data frame, receive a final protocol data unit of a service data unit in an actual final data frame, compare the scheduled final data frame to the actual final data frame, and initiate a sleep mode from the actual final data frame to the scheduled final data frame where the comparing indicates that the actual final data frame is earlier than the scheduled final data frame.

Moreover, the present disclosure contemplates an apparatus for wireless communication, which includes means for receiving scheduling information from a network entity at the mobile station, wherein the scheduling information includes a scheduled final data frame, means for receiving a final protocol data unit of a service data unit in an actual final data frame, means for comparing the scheduled final data frame to the actual final data frame, and means for initiating a sleep mode from the actual final data frame to the scheduled final data frame where the comparing indicates that the actual final data frame is earlier than the scheduled final data frame.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 is a schematic diagram of an example communication system including a mobile station and a network entity each configured to perform corresponding aspects of the present disclosure;

FIG. 2 is a schematic diagram of an aspect of a computer device that may embody the mobile station and/or network entity of FIG. 1;

FIG. 3 is a flow diagram of an aspect of a method of managing power consumption performed by a mobile station;

FIG. 4 is a schematic diagram of a logical grouping in an aspect of a system for managing power consumption in a mobile station;

FIG. 5 is a block diagram illustrating an example of a hardware implementation for an apparatus employing a processing system; and

FIG. 6 illustrates a multiple access wireless communication system according to one embodiment.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

Described herein are various aspects related to improving power consumption of mobile devices. In some aspects of the present disclosure, an MS may receive one or more scheduling messages from a network entity, which may provide relevant information related to the arrival and contents of data messages, such as PDUs, that are to arrive at the MS in the future. In some aspects, this control information may include an expected final data frame associated with one or more data messages to be received by the MS. In other words, the network entity may provide the MS with an estimated schedule as to when each PDU is to arrive and when each PDU is to be fully received.

Before the data messages arrive but after the scheduling information has been received at the MS, however, the network may alter the PDU schedule, such as ending the transmission of one or more PDUs early. In this situation, the previously-received scheduling information may differ from the actual received data contents and receipt period. As such, the MS receiver may remain powered on during blank frames because the MS has anticipated decoding portions of a PDU message or messages during these blank frames in light of the previously-received scheduling information.

As a result, because these blank frames do not contain PDU data, keeping the receiver powered on, or awake, during these blank frames is an unnecessary drain on battery power. Therefore, to conserve power, the present disclosure presents a method and apparatus for detecting the actual final frame of a received PDU. Further, where the PDU has been fully received before the end of a previously-scheduled PDU receive period, the MS may power off, or place into sleep mode, one or more receiver and/or decoding components in the MS until the end of the previously-scheduled PDU receive period.

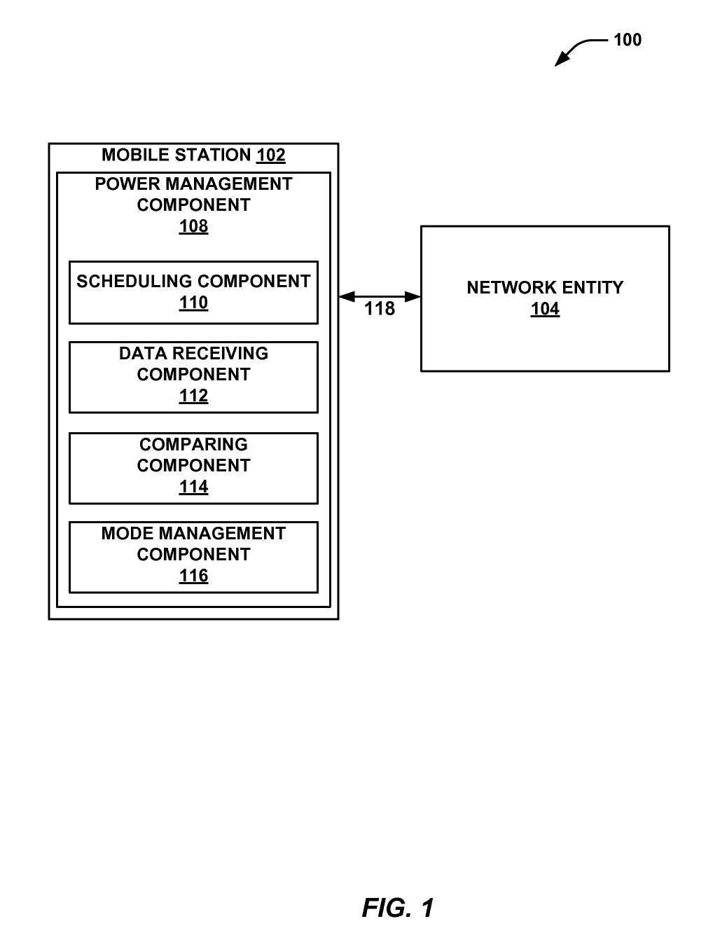

Referring to FIG. 1, a wireless communication system 100 is illustrated that enables power savings in one or more MSs. System 100 includes a MS 102 that communicates with one or more network entities 104 to receive wireless network access. Network entity 104 may include one or more of any type of network component, such as an access point, including a base station (BS) or node B, a relay, a peer-to-peer device, PDSN 106, a radio network controller (RNC), an authentication, authorization and accounting (AAA) server, a mobile switching center (MSC), etc., that can enable MS 102 to communicate and/or that can establish and maintain a communication link 118. In a non-limiting aspect, communication link 118 may be a cell broadcast (CB) and may enable communication of one or more protocol data units (PDUs) over the communication link 118. Furthermore, in an aspect, communication link 118 may be a common traffic channel (CTCH).

Further, in the described aspects, MS 102 includes a power management component 122 configured to conserve power at MS 102 when one or more PDUs are fully received earlier than previously-received scheduling data had indicated. In an aspect, power management component 110 may include a scheduling component 110, which may be configured to receive and/or store scheduling data for data packets to be later received at MS 102. In some aspects, the scheduling data may include a CB schedule message, and may indicate, for each PDU to be received, a scheduled start frame of the PDU, a scheduled final data frame of the PDU, and the scheduled PDU frame length. Furthermore, the term “frame” in the present disclosure represents a unit of receive or transmit time at a transmitter or receiver, and may be alternatively referred to as a “block set.” In addition, it should be appreciated that where the scheduling data is received over a CTCH, the scheduled start frame may be indicated by a received Offset to Begin CTCH Block Set Index and the scheduled PDU frame length may be the Length of Cell Broadcast Service Schedule Period, as defined and published by the Third Generation Partnership Project (3GPP) in the 3GPP TS 25.324 Specification, which is incorporated herein by reference. It is also appreciated that the scheduling data may include Level 1 and Level 2 scheduling messages.

In addition, power management component 108 may include a data receiving component 112, which may be configured to receive one or more data packets, such as PDUs, from one or more network entities 104. Furthermore, data receiving component may store and/or process the one or more data packets, and may include a memory and/or a processor to carry out these functions. In addition, when performing discontinuous reception, data receiving component may be configured to recognize a length indicator message or bit located in a PDU that may indicate that the PDU is the final PDU in an SDU, and may inform other components, such as a comparing component 114, that the final PDU has been received and/or processed. Furthermore, data receiving component may be configured to indicate an actual data frame corresponding to the frame in which the final PDU was received. In an aspect, the actual data frame may be indicated as a block set value and may be passed from the Media Access Control (MAC) layer to a Broadcast/Multicast Control (BMC) layer.

Furthermore, as previously stated, power management component 108 may include a comparing component 114, which may be configured to compare the frame number of a scheduled final data frame to that of an actual final data frame. In an aspect, the comparing component may contain a memory for storing previously-received scheduling information, including, but not limited to, the schedule final data frame and/or the scheduled PDU frame length. From this information and the frame number of the actual final frame of the data PDU, comparing component may determine that the final PDU of an SDU has arrived earlier than expected in light of the scheduling data. In an aspect, this may be a result of the network provider altering the SDU or PDU transmission between the time the scheduling information arrived at the MS 102 and when the final PDU was actually received. In a further aspect, the comparing may occur at the BMC layer.

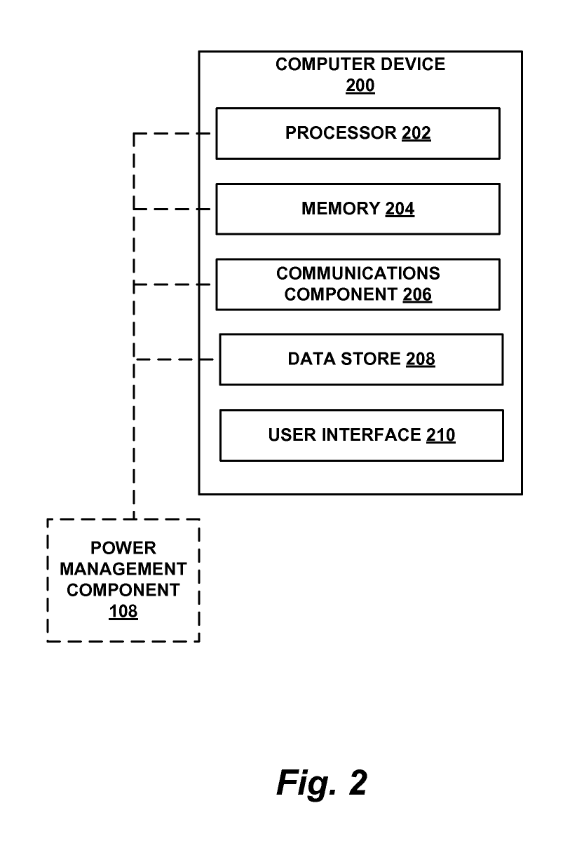

In a further aspect, power management component 108 may include a mode management component 116, which may be configured to alter a power mode of one or more MS components, such as a communications or receiving component, as a result of the output of comparing component 112. In an aspect, where comparing component indicates that the final PDU of an SDU has arrived earlier than expected in light of previously-received scheduling data, mode management component may place, for example, a communications or receiving component, into a sleep mode. In an aspect, mode managing component may cause one or commands from the BMC layer to a physical layer (e.g. MAC layer or Radio Link Control (RLC) layer), which may, in turn, place a communications or receiving component, such as, but not limited to, a modem and/or communications component 46 (FIG. 2).

Referring to FIG. 2, in one aspect, MS 102, for example, including the power management component 108, or the one or more network entities 104 (FIG. 1), may be represented by a specially programmed or configured computer device 200. Computer device 200 includes a processor 202 for carrying out processing functions associated with one or more of components and functions described herein. Processor 202 can include a single or multiple set of processors or multi-core processors. Moreover, processor 202 can be implemented as an integrated processing system and/or a distributed processing system.

Computer device 200 further includes a memory 204, such as for storing data used herein and/or local versions of applications being executed by processor 202. Memory 204 can include any type of memory usable by a computer, such as random access memory (RAM), read only memory (ROM), tapes, magnetic discs, optical discs, volatile memory, non-volatile memory, and any combination thereof.

Further, computer device 200 includes a communications component 206 that provides for establishing and maintaining communications with one or more parties utilizing hardware, software, and services as described herein. Communications component 206 may carry communications between components on computer device 200, as well as between computer device 200 and external devices, such as devices located across a communications network and/or devices serially or locally connected to computer device 200. For example, communications component 206 may include one or more buses, and may further include transmit chain components and receive chain components associated with a transmitter and receiver, respectively, or a transceiver, operable for interfacing with external devices. In a further aspect, communications component may include a modem and/or one or more components to receive communications from power management component 108, such as commands to enter a sleep mode.

Additionally, computer device 200 may further include a data store 208, which can be any suitable combination of hardware and/or software, that provides for mass storage of information, databases, and programs employed in connection with aspects described herein. For example, data store 208 may be a data repository for applications not currently being executed by processor 202.

Computer device 200 may additionally include a user interface component 210 operable to receive inputs from a user of computer device 200, and further operable to generate outputs for presentation to the user. User interface component 210 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 210 may include one or more output devices, including but not limited to a display, a speaker, a haptic feedback mechanism, a printer, any other mechanism capable of presenting an output to a user, or any combination thereof.

In a mobile station implementation, such as for MS 102 of FIG. 1, computer device 200 may include power management component 108, such as in specially programmed computer readable instructions or code, firmware, hardware, or some combination thereof.

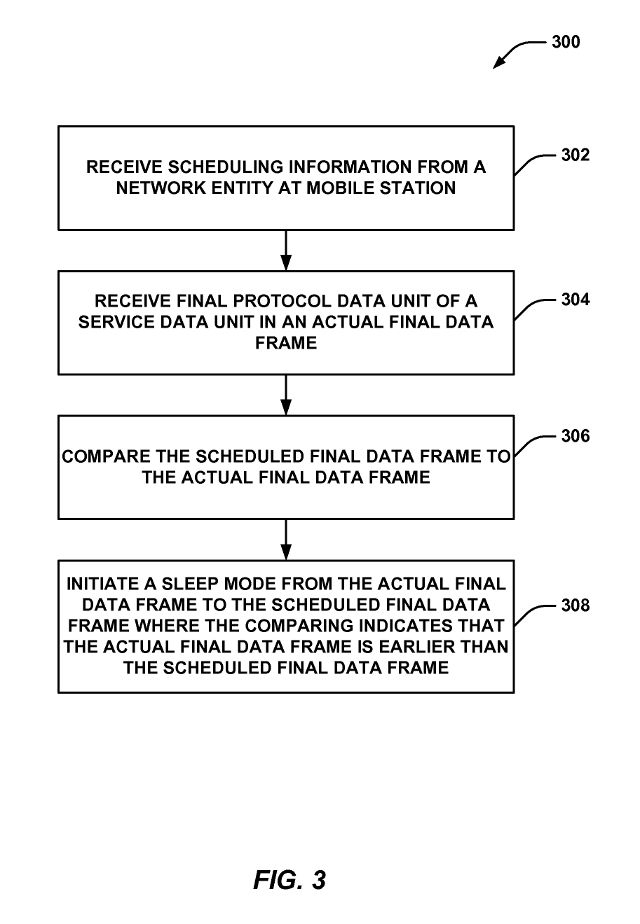

Referring to FIG. 3, an example methodology for power management in a mobile station is implemented. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

Further referring to FIG. 3, an example method 300 for power management, such as at a mobile station or wireless terminal, is illustrated. In an aspect, at block 302, an MS (e.g. MS 102, FIG. 1) and/or a component therein (e.g. data receiving component 112), may receive scheduling information from a network entity. In some aspects, the scheduling data may include a CB schedule message, and may indicate, for each PDU to be received, a scheduled start frame of the PDU, a scheduled final data frame of the PDU, and the scheduled PDU frame length. In addition, it should be appreciated that where the scheduling data is received over a CTCH, the scheduled start frame may be indicated by a received Offset to Begin CTCH Block Set Index and the scheduled PDU frame length may be the Length of Cell Broadcast Service Schedule Period. In another aspect, the scheduled final data frame may be derived from a scheduled start frame of the PDU and the scheduled PDU frame length. It is also appreciated that the scheduling data may include Level 1 and Level 2 scheduling messages. In an aspect, the scheduling information may be stored in a memory for later comparison with an actual final data frame.

Furthermore, at block 304, the MS (e.g. via data receiving component 112 of FIG. 1) may receive a final PDU of an SDU in an actual final data frame. In some examples or aspects, the actual final data frame may be different (e.g. earlier or a lower frame or block set number) than the previously-received scheduled final data frame of the PDU. Moreover, the MS may recognize that the final PDU is the final PDU of the SDU by receiving and decoding a length indicator appended to the final PDU, which indicates the end of transmission of the SDU. Additionally, the actual final data frame indication or frame number may be decoded, derived, stored, and/or computed at the BMC layer.

In a further aspect, at block 306, the MS and/or a component therein (e.g. comparing component 114) may compare the scheduled final data frame to the actual final data frame. In some aspects, this comparison may be conducted at the BMC layer. Furthermore, the MS may determine that the full SDU arrived earlier than scheduled where actual final data frame is less than, or earlier than, the scheduled final data frame. In this case, the MS or component therein may generate a command to power down one or more communication components, such as a receiver, modem, and/or components therein. In an aspect, such a command may be generated at the BMC layer and passed to the physical layer or sub-layers therein (e.g. MAC and/or RLC layers).

As a result of this command, the MS or a component therein (e.g. mode management component 116) may initiate a sleep mode from the actual final data frame to the scheduled final data frame at block 308. Alternatively, where there is a time lag between comparing at block 306 to generating and sending the power down command, the sleep mode may commence at receipt of the command at the communications component that is to initiate the sleep mode. In such a case, the communications component or subcomponents therein may be placed into sleep mode from the moment of command receipt to the scheduled final data frame. As empty or blank frames will likely occur during this sleep mode period, the MS may avoid consuming additional power associated with receiving and decoding these blank frames while assuming negligible risk of data loss.

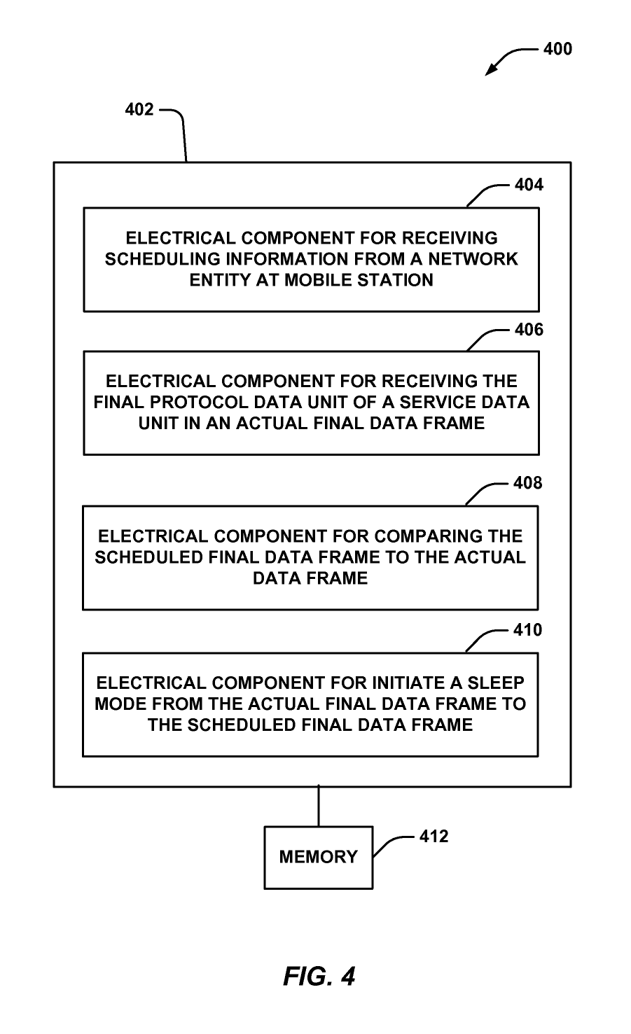

Referring to FIG. 4, an example system 400 may be used for controlling power consumption in an MS, for example, an MS the same as or similar to MS 102 of FIG. 1, including power management component 108. It is to be appreciated that system 400 is represented as including functional blocks, which can be functional blocks that represent functions implemented by a processor, software, or combination thereof (e.g., firmware). System 400 includes a logical grouping 402 of electrical components that can act in conjunction. For instance, logical grouping 402 can include an electrical component 404 for receiving scheduling information from a network entity at a mobile station. In an aspect, electrical component 404 may comprise scheduling component 110 (FIG. 1). Moreover, logical grouping 402 can include an electrical component 406 for receiving a final protocol data unit of a service data unit in an actual final data frame. In an aspect, electrical component 406 may comprise data receiving component 112 (FIG. 1). In addition, logical grouping 402 can include an electrical component 408 for comparing the scheduled final data frame to the actual data frame. In an aspect, electrical component 408 may comprise comparing component 114 (FIG. 1). In a further aspect, logical grouping 402 can include an electrical component 410 for initiating a sleep mode from the actual final data frame to the scheduled final data frame where the comparing at electrical component 408 indicates that the full SDU has arrived early. In an aspect, electrical component 408 may comprise mode management component 116 (FIG. 1).

Additionally, system 400 can include a memory 412 that retains instructions for executing functions associated with the electrical components 404, 406, 408, and 410, stores data used or obtained by the electrical components 404, 406, 408, and 410, etc. While shown as being external to memory 412, it is to be understood that one or more of the electrical components 404, 406, 408, and 410 can exist within memory 416. In one example, electrical components 404, 406, 408, and 410 can comprise at least one processor, or each electrical component 404, 406, 408, and 410 can be a corresponding module of at least one processor. Moreover, in an additional or alternative example, electrical components 404, 406, 408, and 410 can be a computer program product including a computer readable medium, where each electrical component 404, 406, 408, and 410 can be corresponding code.

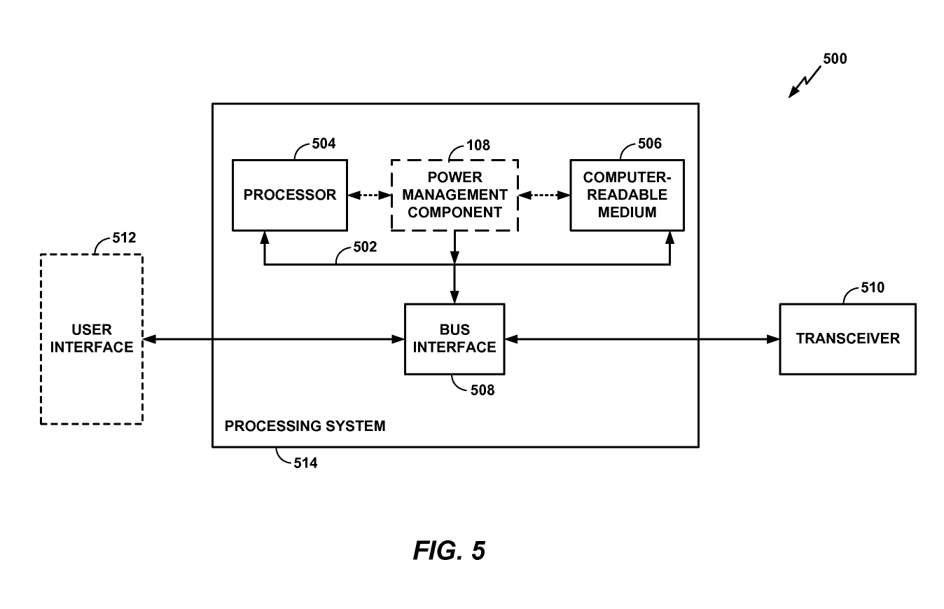

Furthermore, FIG. 5 shows a block diagram illustrating an example of a hardware implementation for an apparatus 500, for example, including the power management component 108 of FIG. 1, employing a processing system 514. In this example, the processing system 514 may be implemented with a bus architecture, represented generally by the bus 502. The bus 502 may include any number of interconnecting buses and bridges depending on the specific application of the processing system 514 and the overall design constraints. The bus 502 links together various circuits including one or more processors, represented generally by the processor 504, computer-readable media, represented generally by the computer-readable medium 506, and, optionally (as represented by the dotted line), power management component 108 (e.g. of FIG. 1). The bus 502 may also link various other circuits such as timing sources, peripherals, voltage regulators, and power management circuits, which are well known in the art, and therefore, will not be described any further. A bus interface 508 provides an interface between the bus 502 and a transceiver 510. The transceiver 510 provides a means for communicating with various other apparatus over a transmission medium. Depending upon the nature of the apparatus, a user interface 512 (e.g., keypad, display, speaker, microphone, joystick) may also be provided.

The processor 504 is responsible for managing the bus 502 and general processing, including the execution of software, such as instructions defining power management component 108, stored on the computer-readable medium 506. The software, when executed by the processor 504, causes the processing system 514 to perform the various functions described infra for any particular apparatus, such as mobile station 102 of FIG. 1. The computer-readable medium 506 may also be used for storing data that is manipulated by the processor 504 when executing software. In addition or alternatively, processor 504 may include one or more processor modules to perform the functions of power management component 108. Furthermore, the apparatus of FIG. 5 may be one or both of mobile station 102 and/or network entity 104 (e.g. of FIG. 1), and may be configured to provide early decoding termination according to aspects of the present disclosure.

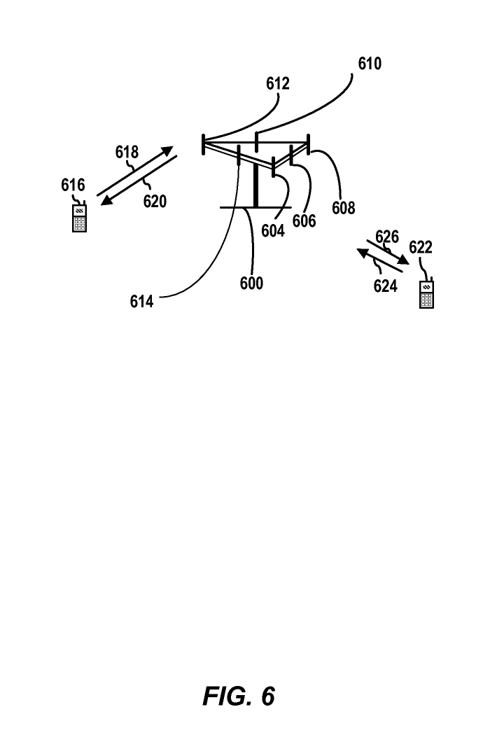

Referring to FIG. 6, a multiple access wireless communication system according to one embodiment is illustrated, and may include aspect of power management component 108 of FIG. 1. An access point 600 (AP), which may be network entity 104 of FIG. 1 in some examples, includes multiple antenna groups, one including 604 and 606, another including 608 and 607, and an additional including 612 and 614. In FIG. 6, only two antennas are shown for each antenna group, however, more or fewer antennas can be utilized for each antenna group. Access terminal 616 (AT) (all access terminals of FIG. 6 may be mobile station 102 of FIG. 1 and may be configured to perform the functions thereof, for example, including power management component 108) is in communication with antennas 612 and 614, where antennas 612 and 614 transmit information to access terminal 616 over forward link 620 and receive information from access terminal 616 over reverse link 618. Access terminal 622 is in communication with antennas 604 and 606, where antennas 604 and 606 transmit information to access terminal 622 over forward link 626 and receive information from access terminal 622 over reverse link 624. In a FDD system, communication links 618, 620, 624 and 626 can use different frequency for communication. For example, forward link 620 can use a different frequency then that used by reverse link 618.

Each group of antennas and/or the area in which they are designed to communicate is often referred to as a sector of the access point. In the embodiment, antenna groups each are designed to communicate to access terminals in a sector of the areas covered by access point 600.

In communication over forward links 620 and 626, the transmitting antennas of access point 600 utilize beamforming in order to improve the signal-to-noise ratio of forward links for the different access terminals 616 and 622. Also, an access point using beamforming to transmit to access terminals scattered randomly through its coverage causes less interference to access terminals in neighboring cells than an access point transmitting through a single antenna to all its access terminals.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Furthermore, various aspects may have been described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, user equipment, or user equipment device. A wireless terminal can be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station can be utilized for communicating with wireless terminal(s) and can also be referred to as an access point, access node, a Node B, evolved Node B (eNB), or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features may have been presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, substantially any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method of conserving battery power in a mobile station, comprising:
receiving scheduling information from a network entity at the mobile station, wherein the scheduling information includes a scheduled final data frame;
receiving a final protocol data unit (PDU) of a service data unit (SDU) in an actual final data frame;
comparing the scheduled final data frame to the actual final data frame;
initiating a sleep mode from the actual final data frame to the scheduled final data frame where the comparing indicates that the actual final data frame is earlier than the scheduled final data frame.

2. The method of claim 1, wherein the scheduling information and final PDU are received on a common traffic channel (CTCH).

3. The method of claim 1, wherein the final data PDU includes a length indicator indicating that the PDU is the final data PDU in the SDU.

4. The method of claim 1, wherein the scheduled final data frame is derived from a common traffic channel (CTCH) scheduling period block set length included in the scheduling information.

5. The method of claim 1, wherein the sleep mode lasts from the actual final data frame to the scheduled final data frame.

6. The method of claim 1, wherein the initiating a sleep mode is a result of a command generated where the comparing indicates that the actual final data frame is earlier than the scheduled final data frame.

7. The method of claim 6, wherein the sleep mode lasts from execution of the command to the scheduled final data frame.

8. An apparatus for wireless communication, comprising:
means for receiving scheduling information from a network entity at the mobile station, wherein the scheduling information includes a scheduled final data frame;
means for receiving a final protocol data unit (PDU) of a service data unit (SDU) in an actual final data frame;
means for comparing the scheduled final data frame to the actual final data frame;
means for initiating a sleep mode from the actual final data frame to the scheduled final data frame where the comparing indicates that the actual final data frame is earlier than the scheduled final data frame.

9. The apparatus claim 8, wherein the scheduling information and final PDU are received on a common traffic channel (CTCH).

10. The apparatus claim 8, wherein the final data PDU includes a length indicator indicating that the PDU is the final data PDU in the SDU.

11. The apparatus claim 8, wherein the scheduled final data frame is derived from a common traffic channel (CTCH) scheduling period block set length included in the scheduling information.

12. The apparatus claim 8, wherein the sleep mode lasts from the actual final data frame to the scheduled final data frame.

13. The apparatus claim 8, wherein the means for initiating a sleep mode is configured to initiate a sleep mode as a result of a command generated where the means for comparing indicates that the actual final data frame is earlier than the scheduled final data frame.

14. The apparatus claim 8, wherein the sleep mode lasts from execution of the command to the scheduled final data frame.

15. A computer program product, comprising:
a computer-readable medium comprising code for:
receiving scheduling information from a network entity at the mobile station, wherein the scheduling information includes a scheduled final data frame;
receiving a final protocol data unit (PDU) of a service data unit (SDU) in an actual final data frame;
comparing the scheduled final data frame to the actual final data frame;
initiating a sleep mode from the actual final data frame to the scheduled final data frame where the comparing indicates that the actual final data frame is earlier than the scheduled final data frame.

16. The computer program product of claim 15, wherein the scheduling information and final PDU are received on a common traffic channel (CTCH).

17. The computer program product of claim 15, wherein the final data PDU includes a length indicator indicating that the PDU is the final data PDU in the SDU.

18. The computer program product of claim 15, wherein the scheduled final data frame is derived from a common traffic channel (CTCH) scheduling period block set length included in the scheduling information.

19. The computer program product of claim 15, wherein the sleep mode lasts from the actual final data frame to the scheduled final data frame.

20. The computer program product of claim 15, wherein the initiating a sleep mode is a result of a command generated where the comparing indicates that the actual final data frame is earlier than the scheduled final data frame.

21. The computer program product of claim 20, wherein the sleep mode lasts from execution of the command to the scheduled final data frame.

22. An apparatus for wireless communication, comprising:
at least one processor; and
a memory coupled to the at least one processor, wherein the at least one processor is configured to:
receive scheduling information from a network entity at the mobile station, wherein the scheduling information includes a scheduled final data frame;
receive a final protocol data unit (PDU) of a service data unit (SDU) in an actual final data frame;
compare the scheduled final data frame to the actual final data frame;
initiate a sleep mode from the actual final data frame to the scheduled final data frame where the comparing indicates that the actual final data frame is earlier than the scheduled final data frame.

23. The apparatus of claim 22, wherein the scheduling information and final PDU are received on a common traffic channel (CTCH).

24. The apparatus of claim 22, wherein the final data PDU includes a length indicator indicating that the PDU is the final data PDU in the SDU.

25. The apparatus of claim 22, wherein the scheduled final data frame is derived from a common traffic channel (CTCH) scheduling period block set length included in the scheduling information.

26. The apparatus of claim 22, wherein the sleep mode lasts from the actual final data frame to the scheduled final data frame.

27. The apparatus of claim 22, wherein the initiating a sleep mode is a result of a command generated where the comparing indicates that the actual final data frame is earlier than the scheduled final data frame.

28. The apparatus of claim 27, wherein the sleep mode lasts from execution of the command to the scheduled final data frame.
